(19) United States
(12) Patent Application Publication
(10) Pub. No.: US 2018/0349253 A1
(43) Pub. Date: Dec. 6, 2018

(54) ERROR HANDLING FOR DEVICE PROGRAMMERS AND PROCESSORS

(71) Applicant: Intel Corporation, Santa Clara, CA (US)

(72) Inventor: James S. Woodward, Vancouver, WA (US)

(21) Appl. No.: 15/612,822

(22) Filed: Jun. 2, 2017

(51) Int. Cl. G06F 11/36

(52) U.S. Cl. CPC G06F 11/3656; G06F 11/3664

(57) ABSTRACT

Embodiments include apparatuses, methods, and computer devices including a processor and a device programmer coupled to the processor. The processor may detect an error during an execution of a program on the processor, and transmit an error message to the device programmer. Afterwards, the processor may receive a probe input signal from the device programmer to stop the execution of the program on the processor, and transmit a probe output signal to the device programmer to indicate that the execution of the program on the processor has stopped. On the other hand, the device programmer may receive the error message from the processor, and transmit the probe input signal to the processor to stop the execution of the program on the processor. Afterwards, the device programmer may receive the probe output signal from the processor.

### FIELD

Embodiments of the present invention relate generally to the technical field of computing, and more particularly to error handling for device programmers and processors in a computer device.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Debugging is a process of finding and resolving errors or defects that prevent operations of a computer program, software, or a system on a computer device. When a computer device encounters an error in an execution of a program, often the computer device may reset the execution or crash the computer device. In doing so, the computer device may lose the operational state of the program at the time of the error, which makes it harder to discover and fix the cause of the error. When an error occurs, an additional or dedicated debugging tool, e.g., Intel® Test Port™ (ITP), may be plugged into the computer device to stop the execution of the program and to recreate the error for debugging purpose. The additional or dedicated debugging tool may include an external debug apparatus, e.g., —Extensible Test Platform (XTP) or other Joint Test Action Group (JTAG) devices, attached to the computer device through an Extensible Test Platform (XTP), or a Peripheral Control Hub (PCH).

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example computer device including a processor coupled to a device programmer to stop an execution of a program on the processor without an additional or dedicated debugging tool when an error occurs, in accordance with various embodiments.

FIG. 2 illustrates another example computer device including a debug agent in addition to a processor coupled to a device programmer to stop an execution of a program on the processor when an error occurs, in accordance with various embodiments.

FIG. 3 illustrates an example debug apparatus coupled to an example computer device including a processor coupled to a device programmer to stop an execution of a program on the processor when an error occurs, in accordance with various embodiments.

FIG. 4 illustrates an example error handling process for a processor included in a computer device, in accordance with various embodiments.

FIG. 5 illustrates an example error handling process for a device programmer included in a computer device, in accordance with various embodiments.

FIG. 6 illustrates another example error handling process for a device programmer included in a computer device, in accordance with various embodiments.

FIG. 7 illustrates an example device suitable for use to practice various aspects of the present disclosure, in accordance with various embodiments.

FIG. 8 illustrates a storage medium having instructions for practicing methods described with references to FIGS. 1-7, in accordance with various embodiments.

### DETAILED DESCRIPTION

When a computer device encounters an error in an execution of a program, often the computer device may reset the execution or crash the computer device, resulting in loss of the operational state of the program at the time of the error. An additional or dedicated debugging tool may be plugged into the computer device to stop the execution of the program and to recreate the error for debugging purpose. In embodiments, a device programmer coupled to a processor of the computer device may stop or halt the execution of a program on the processor, without resetting the execution or crashing the computer device, and without additional debugging tools. The processor may further preserve an operational state of the program at a time of the error, which may be extracted by a debugging tool or a debug apparatus at a later time. In embodiments, a debugging tool may be referred to as a debug apparatus, or a debug agent.

In embodiments, a computer device may include a processor and a device programmer coupled to the processor. The device programmer may receive an error message from the processor during an execution of a program on the processor. The device programmer may also transmit a probe input signal to the processor to halt the execution of the program on the processor. Afterwards, the device programmer may receive a probe output signal from the processor to indicate that the execution of the program on the processor is halt.

In embodiments, a computer device may include a register and a processor coupled to the register. The processor may detect an error during an execution of a program on the processor, and transmit an error message to a device programmer coupled to the processor. Furthermore, the processor may receive a probe input signal from the device programmer to stop the execution of the program on the processor. On stoppage, the processor may transmit a probe output signal to the device programmer to indicate that the execution of the program on the processor has stopped.

In embodiments, a computer device may include a processor and a device programmer coupled to the processor. The processor may detect an error during an execution of a program on the processor, and transmit an error message to the device programmer. Afterwards, the processor may receive a probe input signal from the device programmer to stop the execution of the program on the processor, and transmit a probe output signal to the device programmer to indicate that the execution of the program on the processor has stopped. In addition, the device programmer may receive the error message from the processor, and transmit the probe input signal to the processor to stop the execution of the program on the processor. Afterwards, the device programmer may receive the probe output signal from the processor.

In the description to follow, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Operations of various methods may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiments. Various additional operations may be performed and/or described operations may be omitted, split or combined in additional embodiments.

For the purposes of the present disclosure, the phrase “A or B” and “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used hereinafter, including the claims, the term “module” or “routine” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

The terms “coupled with” and “coupled to” and the like may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. By way of example and not limitation, “coupled” may mean two or more elements or devices are coupled by electrical connections on a printed circuit board such as a motherboard, for example. By way of example and not limitation, “coupled” may mean two or more elements/devices cooperate and/or interact through one or more network linkages such as wired and/or wireless networks. By way of example and not limitation, a computing apparatus may include two or more computing devices “coupled” on a motherboard or by one or more network linkages.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

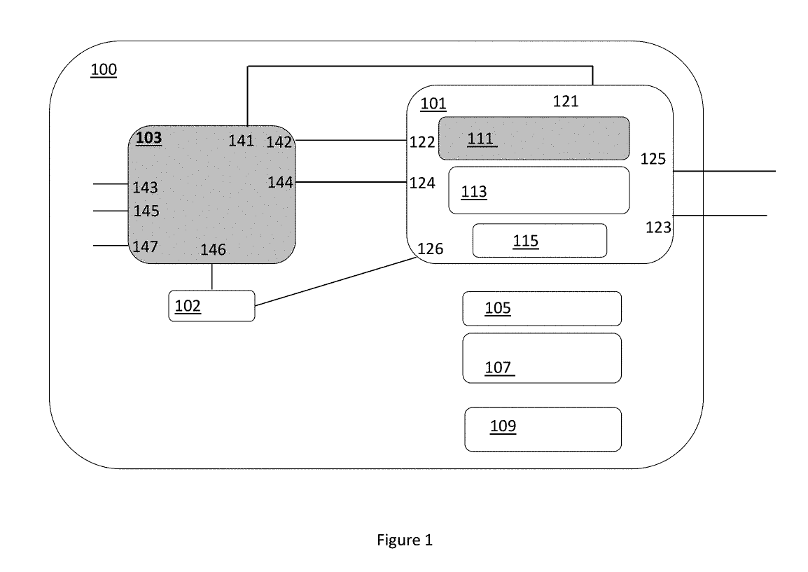

FIG. 1 illustrates an example computer device 100 including a processor 101 coupled to a device programmer 103 to stop an execution of a program 115 on the processor 101 without an additional or dedicated debugging tool when an error occurs, in accordance with various embodiments. For clarity, features of the computer device 100 may be described below as an example for understanding an example computer device that may include a processor coupled to a device programmer to stop an execution of a program on the processor when an error occurs. It is to be understood that there may be more or fewer components included in the computer device 100. Further, it is to be understood that one or more of the devices and components within the computer device 100 may include additional and/or varying features from the description below, and may include any device that one having ordinary skill in the art would consider and/or refer to as a computer device.

In embodiments, the computer device 100 may include the processor 101 and the device programmer 103. In addition, the computer device 100 may include other components, e.g., a programmable logic device (PLD) 102, a register 105, a memory 107, and a timer 109. The processor 101 may include a debug logic 111 and/or a program counter 113, while the program 115 may run on the processor 101. In embodiments, the processor 101, the device programmer 103, the PLD 102, the register 105, the memory 107, the timer 109, the debug logic 111, the program counter 113, and the program 115 may be any processor, device programmer, PLD, register, memory, timer, debug logic, program counter, and program that one having ordinary skill in the art would consider and/or refer to as a processor, a device programmer, a PLD, a register, a memory, a timer, a debug logic, a program counter, and a program, respectively.

In embodiments, the computer device 100 may be a system on chip (SOC), integrating the processor 101, the device programmer 103, the PLD 102, cache, random access memory (RAM), peripheral functions, or other functions onto one chip. Alternatively, the computer device 100 may be a system integrated on a same circuit board to include the processor 101, the device programmer 103, the PLD 102, the memory 107, and other components. The computer device 100 may be for various applications such as wireless communication, digital signal processing, security, and other applications.

In embodiments, the processor 101 may be a central processing unit (CPU). In some embodiments, the processor 101 may be a programmable device that may execute a program, e.g., the program 115. In embodiments, the processor 101 may be a microcontroller, a 16-bit processor, a 32-bit processor, a 64-bit processor, a single core processor, a multi-core processor, a digital signal processor, an embedded processor, or any other processor.

In embodiments, the processor 101 may execute the program 115, with the aid of the programmer counter 113. The program 115 may be a thread of another program, or a component of a process, which may be the smallest sequence of programmed instructions that may be managed independently by a scheduler, e.g., a part of the operating system for the processor 101. There may be multiple threads executing concurrently on the processor 101 while sharing resources such as the memory 107. In embodiments, the program 115 may be a single thread or multiple threads.

In embodiments, the processor 101 may be in various modes, such as an operational mode, an error mode, a waiting mode, a sleeping mode, or a debug mode. The processor 101 may be in an operational mode when the program 115 may be executing on the processor 101. An instruction, e.g., Halt, may be issued by an operating system to stop the operation of the processor 101 and bring the processor 101 into a waiting mode, or a sleeping mode. The processor 101 may enter an error mode when the execution of the program 115 may not continue its normal execution flow. The processor 101 may generate an error message in an error mode. There may be many kinds of error messages, such as an exception, an input/output error, a fatal error, or a recoverable error.

In embodiments, the processor 101 may include the debug logic 111. The debug logic 111 may include debug logic registers, or on-chip trace buffers to collect data on the execution flow of the program 115. In addition, the debug logic 111 may redirect the processor 101 to fetch the next instruction from the debug logic registers instead of the program counter 113, thus taking control of the processor 101 to perform debug operations for the program 115.

In embodiments, the PLD 102 may be a reconfigurable circuit, and may include a combination of a logic device and a memory device. The PLD 102 may include a programmable array logic (PAL), a generic array logic (GAL), a programmable logic device (PLD), a simple programmable logic device (SPLD), a complex programmable logic device (CPLD), or a field programmable gate array (FPGA). A traditional computer device may not integrate the PLD 102 and the processor 101 together. The integration of the processor 101 and the PLD 102 may provide higher performance, shorter time-to-market, and lower manufacturing costs for the computer device 100. The processor 101 and the PLD 102 may work together for various applications. The combination or configuration of operations for the processor 101 and the PLD 102 may depend on the applications the computer device 100 is for. In embodiments, high performance operations may be allocated to be implemented on the PLD 102, while less stringent performance operations may be implemented by the program 115 on the processor 101.

In embodiments, the device programmer 103 may be used to program or reconfigure the PLD 102. For example, the device programmer 103 may transfer a Boolean logic pattern into the PLD 102 to program the PLD 102. The PLD 102 may have an undefined function at the time of manufacture. Before the PLD 102 may be used in the computer device 100, the PLD 102 may be programmed or reconfigured by the device programmer 103. In embodiments, the device programmer 103 may be a gang programmer, a development programmer, a pocket programmer, or a specialized programmer. Additionally and alternatively, in embodiments, the device programmer 103 may be any processor or controller that may receive an interrupt, such as an error message from the processor 101, and may generate a command, such as a halt command, to the processor 101. In some embodiments, the device programmer 103 and the processor 101 may be any dual processors in the computer device 100, and the computer device 100 may be without the PLD 102.

In embodiments, the processor 101 may include an error message port 121, a probe input signal port 122, a probe output signal port 124, a debug data port 123, a power port 125, and a data port 126. The power port 125 may be coupled to a power source to supply power to the processor 101. The processor 101 may transmit an error message through the error message port 121. The processor 101 may be coupled to the PLD 102 through the data port 126. Furthermore, the probe input signal port 122, the probe output signal port 124, and the debug data port 123 may be used for debugging purpose to identify an error of a program. In embodiments, the debug data port 123 may be a JTAG port, or other debug port used to transmit data, e.g., a preserved operational state of the program 115 at a time of error, for debugging purpose. Traditionally, the probe input signal port 122, the probe output signal port 124, and the debug data port 123 may be coupled to a dedicated debugging tool, e.g., a debug agent or an external debug apparatus, which may be used for debugging purpose only.

In embodiments, the device programmer 103 may include an error message port 141, a probe input signal port 142, a probe output signal port 144, a debug data port 143, a power port 145, an enablement port 147, and a data port 146. The error message port 141 may be coupled to the error message port 121 of the processor 101 to receive an error message from the processor 101. The data port 146 may be coupled to the PLD 102 to facilitate the computations designed for the PLD 102. The power port 145 may be coupled to a power source to supply power to the device programmer 103.

Traditionally, a device programmer designed for programming the PLD 102 may not have any probe input signal port, probe output signal port, or debug data port. In embodiments, the probe input signal port 142 may be coupled to the probe input signal port 122 to transmit a probe input signal, e.g., a probe request (PREQ) signal, between the processor 101 and the device programmer 103. The probe output signal port 144 may be coupled to the probe output signal port 124 to transmit a probe output signal, e.g., a control ready (PRDY) signal, between the processor 101 and the device programmer 103. The debug data port 143 may be a JTAG port, or other debug port used to transmit data, e.g., a preserved operational state of the program 115 at a time of error, for debugging purpose.

The connection between the probe input signal port 142 and the probe input signal port 122, and the connection between the probe output signal port 144 and the probe output signal port 124, may be different from a connection with a dedicated or additional debugging tool to the probe input signal port 122 or a connection with a dedicated or additional debugging tool to the probe output signal port 124. For example, a connection between a dedicated debugging tool and the probe input signal port 122 may not exist during the normal operation of the processor 101, and a dedicated debug tool may be coupled to the probe input signal port 122 when an error is encountered. Furthermore, a connection between a dedicated debugging tool and the probe input signal port 122 may be removed once the debugging has been finished. On the other hand, the connection between the probe input signal port 142 and the probe input signal port 122, and the connection between the probe output signal port 144 and the probe output signal port 124, may be formed at the time the processor 101 and the device program 103 are manufactured, and may not be disconnected during the lifetime of the computer device 100.

In embodiments, the device programmer 103 may include the enablement port 147. The enablement port 147 may be used to enable or disable other ports related to debugging. For example, the enablement port 147 may be used to enable the probe input signal port 142, the probe output signal port 144, or the debug data port 143, so that the device programmer 103 may transmit a probe input signal, e.g., a probe request (PREQ) signal, or a probe output signal, e.g., a control ready (PRDY) signal, between the processor 101 and the device programmer 103. Similarly, the enablement port 147 may be used to disable the probe input signal port 142, the probe output signal port 144, or the debug data port 143, so that the device programmer 103 may not participate in the debugging of an error for the processor 101.

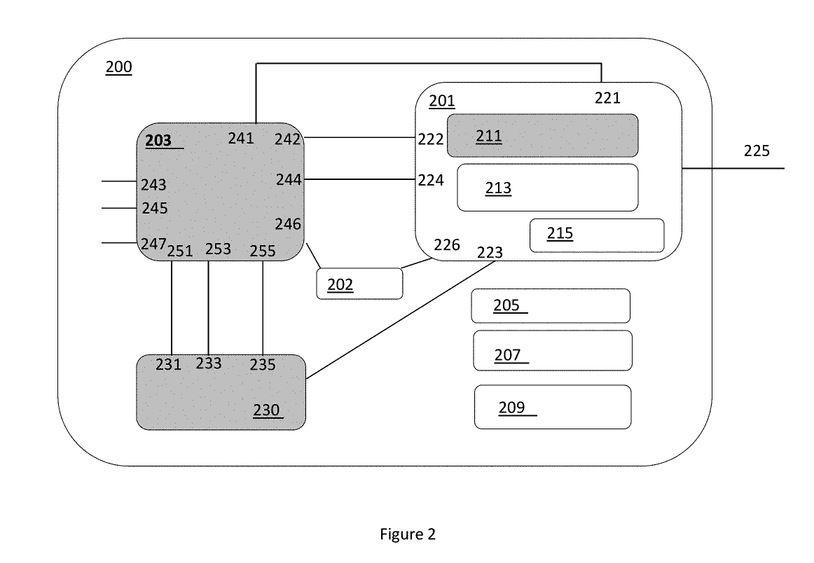

FIG. 2 illustrates another example computer device 200 including a debug agent 230 in addition to a processor 201 coupled to a device programmer 203 to stop an execution of a program 205 on the processor 201 when an error occurs, in accordance with various embodiments. The computer device 200 may be similar to the computer device 100 shown in FIG. 1.

In embodiments, the computing device 200 may include the processor 201 and the device programmer 203, which may be similar to the processor 101 and the device programmer 103 respectively. In addition, the computer device 200 may include other components, e.g., a programmable logic device (PLD) 202, a register 205, a memory 207, and a timer 209. The processor 201 may include a debug logic 211 and/or a program counter 213, while the program 215 may run on the processor 201. In embodiments, the PLD 202, the register 205, the memory 207, the timer 209, the debug logic 211, the program counter 213, and the program 215 may be similar to the PLD 102, the register 105, the memory 107, the timer 109, the debug logic 111, the program counter 113, and the program 115, respectively. Furthermore, the processor 201, the device programmer 203, the PLD 202, the register 205, the memory 207, the timer 209, the debug logic 211, the program counter 213, and the program 215 may be any processor, device programmer, PLD, register, memory, timer, debug logic, program counter, and program that one having ordinary skill in the art would consider and/or refer to as a processor, a device programmer, a PLD, a register, a memory, a timer, a debug logic, a program counter, and a program. In addition, the computing device 200 may include the debug agent 230, which may not be included in the computing device 100.

In embodiments, the processor 201 may include an error message port 221, a probe input signal port 222, a probe output signal port 224, a debug data port 223, a power port 225, and a data port 226. The power port 225 may be coupled to a power source to supply power to the processor 201. The processor 201 may transmit an error message through the error message port 221. The processor 201 may be coupled to the PLD 202 through the data port 226. Furthermore, the probe input signal port 222, the probe output signal port 224, and the debug data port 223 may be used for debugging purpose to identify an error of a program, similar to the probe input signal port 122, the probe output signal port 124, and the debug data port 123, respectively.

In embodiments, the device programmer 203 may include an error message port 241, a probe input signal port 242, a probe output signal port 244, a debug data port 243, a power port 245, an enablement port 247, and a data port 246. The error message port 241 may be coupled to the error message port 221 of the processor 201 to receive an error message from the processor 201. The data port 246 may be coupled to the PLD 202 to facilitate the computations designed for the PLD 202. The power port 245 may be coupled to a power source to supply power to the device programmer 203.

In embodiments, the probe input signal port 242 may be coupled to the probe input signal port 222 to transmit a probe input signal, e.g., a probe request (PREQ) signal, between the processor 201 and the device programmer 203. The probe output signal port 244 may be coupled to the probe output signal port 224 to transmit a probe output signal, e.g., a control ready (PRDY) signal, between the processor 201 and the device programmer 203. The debug data port 243 may be a JTAG port, or other debug port, used to transmit data for debugging purpose. The enablement port 247 may be used to enable or disable other ports related to debugging, e.g., the probe input signal port 242, the probe output signal port 244, or the debug data port 243.

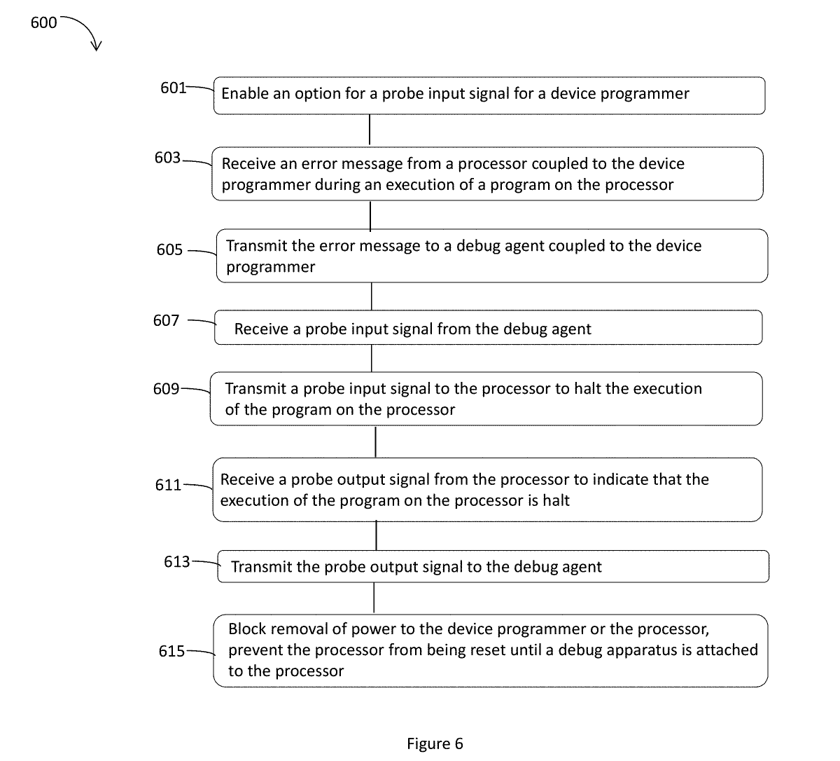

In embodiments, the device programmer 203 may further include a second error message port 251, a second probe input signal port 253, and a second probe output signal port 255, coupled, respectively, to an error message port 231, a probe input signal port 233, and a probe output signal port 235 of the debug agent 230. In embodiments, the debug agent 230 may be referred to as a debug header. The debug agent 230 may be a dedicated debugging tool, instead of a part of the normal application functions for the computer device 200. In embodiments, the debug agent 230 may be located on a same chip or a same circuit board as the processor 201 and the device programmer 203. Error messages, a probe input signal, and a probe output signal may be transmitted between the device programmer 203 and the debug agent 230 through the error message ports, probe input signal ports, and probe output signal ports. Operations involving the debug agent 230 may be illustrated in FIG. 6.

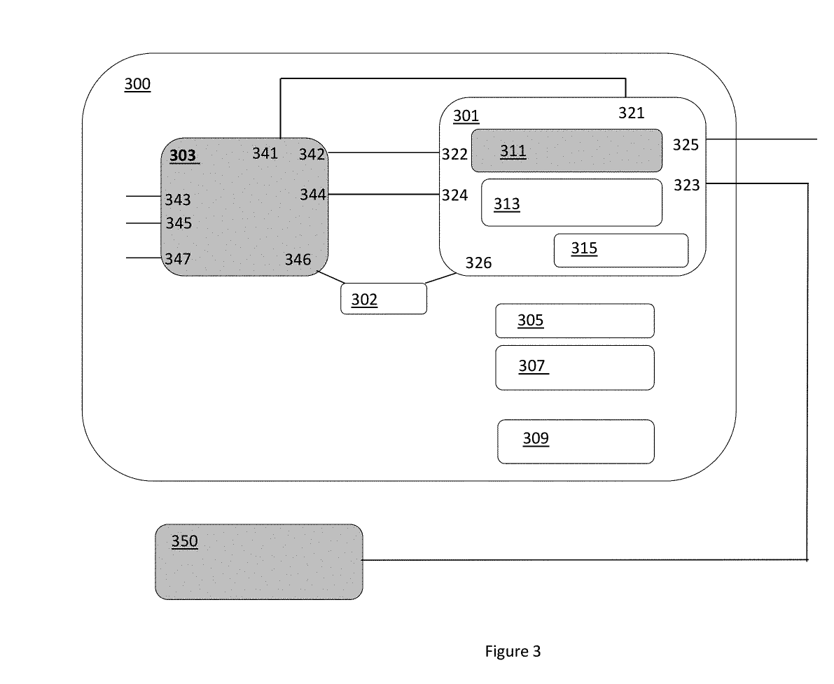

FIG. 3 illustrates an example debug apparatus 350 coupled to an example computer device 300 including a processor 301 coupled to a device programmer 303 to stop an execution of a program 315 on the processor 301 when an error occurs, in accordance with various embodiments. The computer device 300 may be similar to the computer device 100 shown in FIG. 1.

In embodiments, the computing device 300 may include the processor 301 and the device programmer 303, which may be similar to the processor 101 and the device programmer 103, respectively. In addition, the computer device 300 may include other components, e.g., a PLD 302, a register 305, a memory 307, and a timer 309. The processor 301 may include a debug logic 311 and/or a program counter 313, while the program 315 may run on the processor 301. In embodiments, the PLD 302, the register 305, the memory 307, the timer 309, the debug logic 311, the program counter 313, and the program 315 may be similar to the PLD 102, the register 105, the memory 107, the timer 109, the debug logic 111, the program counter 113, and the program 115, respectively. Furthermore, the processor 301, the device programmer 303, the PLD 302, the register 305, the memory 307, the timer 309, the debug logic 311, the program counter 313, and the program 315 may be any processor, device programmer, PLD, register, memory, timer, debug logic, program counter, and program that one having ordinary skill in the art would consider and/or refer to as a processor, a device programmer, a PLD, a register, a memory, a timer, a debug logic, a program counter, and a program.

In embodiments, the processor 301 may include an error message port 321, a probe input signal port 322, a probe output signal port 324, a debug data port 323, a power port 325, and a data port 326. The power port 325 may be coupled to a power source to supply power to the processor 301. The processor 301 may transmit an error message through the error message port 321. The processor 301 may be coupled to the PLD 302 through the data port 326. Furthermore, the probe input signal port 322, the probe output signal port 324, and the debug data port 323 may be used for debugging purpose to identify an error of a program, similar to the probe input signal port 122, the probe output signal port 124, and the debug data port 123, respectively.

In embodiments, the device programmer 303 may include an error message port 341, a probe input signal port 342, a probe output signal port 344, a debug data port 343, a power port 345, an enablement port 347, and a data port 346. The error message port 341 may be coupled to the error message port 321 of the processor 301 to receive an error message from the processor 301. The data port 346 may be coupled to the PLD 302 to facilitate the computations designed for the PLD 302. The power port 345 may be coupled to a power source to supply power to the device programmer 303.

In embodiments, the probe input signal port 342 may be coupled to the probe input signal port 322 to transmit a probe input signal, e.g., a probe request (PREQ) signal, between the processor 301 and the device programmer 303. The probe output signal port 344 may be coupled to the probe output signal port 324 to transmit a probe output signal, e.g., a control ready (PRDY) signal, between the processor 301 and the device programmer 303. The debug data port 343 may be a JTAG port, or other debug port used to transmit data for debugging purpose. The enablement port 347 may be used to enable or disable other ports related to debugging, e.g., the probe input signal port 342, the probe output signal port 344, or the debug data port 343.

In embodiments, the debug apparatus 350 may be a dedicated debugging tool, performing only debugging functions. In embodiments, the debug apparatus 350 may be an external debug apparatus, and located outside a chip or a circuit board where the processor 301 and the device programmer 303 may be located. For example, the debug apparatus 350 may be located in a PCH. The debug apparatus 350 may be coupled to the processor 301 through the debug data port 323. The connection between the processor 301 and the debug apparatus 350 through the debug data port 323 may be established after an error has been detected by the processor 301. In addition, the connection between the processor 301 and the debug apparatus 350 through the debug data port 323 may be established after the execution of the program 315 has stopped. The processor 301 may preserve an operational state of the program 315 at a time of the error, and may further transmit the preserved operational state to the debug apparatus 350. In some other embodiments, the debug apparatus 350 may be further coupled to the processor 301 through the error message port 321, the probe input signal 322, and the probe output signal 324, so that the debug apparatus 350 may control the processor 301 in more capacity. For example, the debug apparatus 350 may receive an error message from the processor 301 during an execution of the program 315, transmit a probe input signal to the processor 301 to halt the execution of the program 315, and receive a probe output signal from the processor 301 to indicate that the execution of the program 315 on the processor 301 is halt.

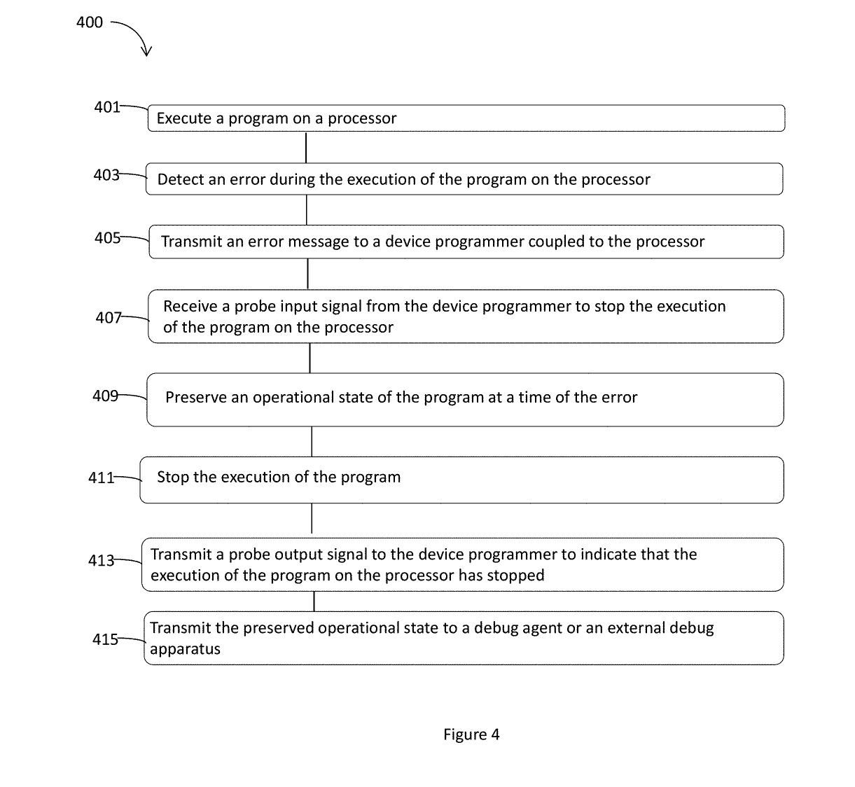

FIG. 4 illustrates an example error handling process 400 for a processor included in a computer device, in accordance with various embodiments. In embodiments, the process 400 may be a process performed by the processor 101 in FIG. 1, the processor 201 in FIG. 2, or the processor 301 in FIG. 3. The following descriptions are provided using the processor 301 as an example.

The process 400 may start at an interaction 401. During the interaction 401, the processor may execute a program on the processor. For example, at the interaction 401, the processor 301 may execute the program 315.

During an interaction 403, the processor may detect an error during the execution of the program on the processor. For example, at the interaction 403, the processor 301 may detect an error during the execution of the program 315 on the processor 301.

During an interaction 405, the processor may transmit an error message to a device programmer coupled to the processor. For example, at the interaction 405, the processor 301 may transmit an error message to the device programmer 303 through the connection between the error message port 341 and the error message port 321.

During an interaction 407, the processor may receive a probe input signal from the device programmer to stop the execution of the program on the processor. For example, at the interaction 407, the processor 301 may receive a probe input signal from the device programmer 303 to stop the execution of the program 315 on the processor 301. The probe input signal may be a probe request (PREQ) signal, and may be transmitted through the connection between the probe input signal port 342 and the probe input signal port 322.

During an interaction 409, the processor may preserve an operational state of the program at a time of the error. For example, at the interaction 409, the processor 301 may preserve an operational state of the program 315 at a time of the error. The preserved operational state may be stored in the debug logic 311.

During an interaction 411, the processor may stop the execution of the program. For example, at the interaction 411, the processor 301 may stop the execution of the program 315.

During an interaction 413, the processor may transmit a probe output signal to the device programmer to indicate that the execution of the program on the processor has stopped. For example, at the interaction 413, the processor 301 may transmit a probe output signal to the device programmer 303 to indicate that the execution of the program 315 on the processor 301 has stopped. The probe output signal may be a control ready (PRDY) signal, and may be transmitted through the connection between probe output signal port 344 and the probe output signal port 324.

During an interaction 415, the processor may transmit the preserved operational state to a debug agent or an external debug apparatus. For example, at the interaction 415, the processor 301 may transmit the preserved operational state to the debug apparatus 350, which may be external to the computer device 300. In some other embodiments, at the interaction 409, the processor 201 may transmit the preserved operational state to the debug agent 230, which may be included in the computer device 200.

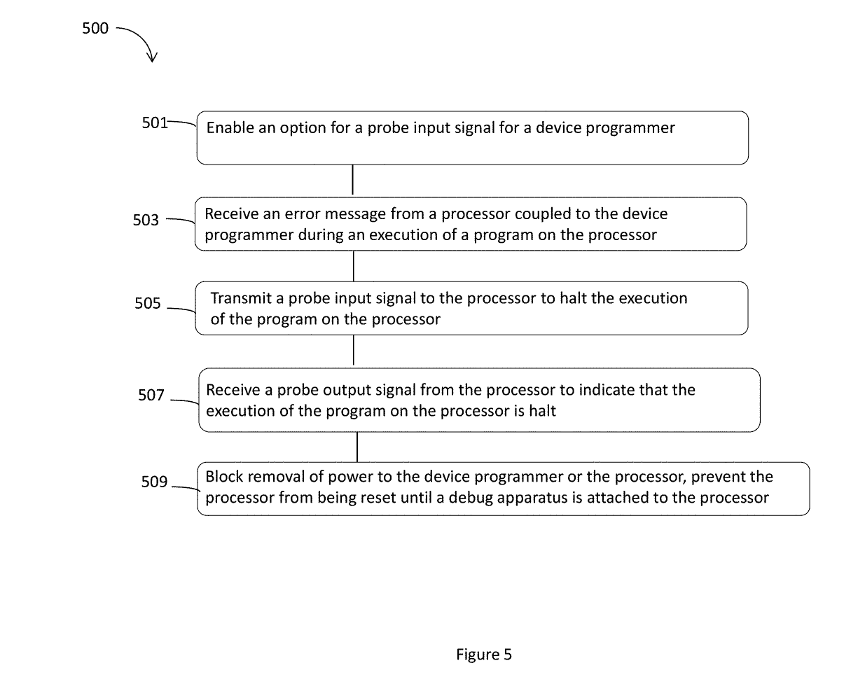

FIG. 5 illustrates an example error handling process 500 for a device programmer included in a computer device, in accordance with various embodiments. In embodiments, the process 500 may be a process performed by the device programmer 103 in FIG. 1, the device programmer 203 in FIG. 2, or the device programmer 303 in FIG. 3. The following descriptions are provided using the processor 301 as an example.

The process 500 may start at an interaction 501. During the interaction 501, the device programmer may enable an option for a probe input signal for the device programmer. For example, at the interaction 501, the device programmer 303 may enable an option through the enablement port 347 for a probe input signal to be transmitted through the probe input signal port 342. In some embodiments, the device programmer 303 may also enable an option through the enablement port 347 for a probe output signal to be transmitted through the probe output signal port 344, or enable an option through the enablement port 347 for debug data to be transmitted through the debug data port 343.

During an interaction 503, the device programmer may receive an error message from a processor coupled to the device programmer during an execution of a program on the processor. For example, at the interaction 503, the device programmer 303 may receive an error message from the processor 301 during an execution of the program 315 on the processor. The error message may be received through the connection between the error message port 341 and the error message port 321.

During an interaction 505, the device programmer may transmit a probe input signal to the processor to halt the execution of the program on the processor. For example, at the interaction 505, the device programmer 303 may transmit a probe input signal to the processor 301 to halt the execution of the program 315 on the processor 301. The probe input signal, e.g., a probe request (PREQ) signal, may be transmitted through the connection between the probe input signal port 342 and the probe input signal port 322.

During an interaction 507, the device programmer may receive a probe output signal from the processor to indicate that the execution of the program on the processor is halt. For example, at the interaction 507, the device programmer 303 may receive a probe output signal, e.g., a control ready (PRDY) signal, from the processor 301 to indicate that the execution of the program 315 on the processor 301 is halt. The probe output signal may be received through the connection between the probe output signal port 344 and the probe output signal port 324.

During an interaction 509, the device programmer may block removal of power to the device programmer or the processor, and prevent the processor from being reset until a debug apparatus is attached to the processor. For example, at the interaction 509, the device programmer 303 may block removal of power to the device programmer 303 or the processor 301, and prevent the processor 301 from being reset until a debug apparatus is attached to the processor. In embodiments, the device programmer 303 may block removal of power to the device programmer or the processor through controlling the power port 345 or the power port 325. The device programmer 303 may detect that the debug apparatus 350 is attached to the processor 301 through the debug data port 323.

FIG. 6 illustrates another example error handling process 600 for a device programmer included in a computer device, in accordance with various embodiments. In embodiments, the process 600 may be a process performed by the device programmer 203 in FIG. 2, where the debug agent 230 may be included in the computer device 200. The device programmer 203 may work together with the debug agent 230 to perform the error handling process 600.

The process 600 may start at an interaction 601. During the interaction 601, the device programmer may enable an option for a probe input signal for the device programmer. For example, at the interaction 601, the device programmer 203 may enable an option through the enablement port 247 for a probe input signal to be transmitted through the probe input signal port 242. In some embodiments, the device programmer 203 may also enable an option through the enablement port 247 for a probe output signal to be transmitted through the probe output signal port 244, or enable an option through the enablement port 247 for debug data to be transmitted through the debug data port 243.

During an interaction 603, the device programmer may receive an error message from a processor coupled to the device programmer during an execution of a program on the processor. For example, at the interaction 603, the device programmer 203 may receive an error message from the processor 201 during an execution of the program 215 on the processor. The error message may be received through the connection between the error message port 241 and the error message port 221.

During an interaction 605, the device programmer may transmit the error message to a debug agent coupled to the device programmer. For example, at the interaction 605, the device programmer 203 may transmit the error message to the debug agent 230. The error message may be transmitted through the connection between the error message port 231 and the error message port 251.

During an interaction 607, the device programmer may receive a probe input signal from the debug agent. For example, at the interaction 607, the device programmer 203 may receive a probe input signal from the debug agent 230. The probe input signal may be received through the connection between the probe input signal port 253 and the probe input signal port 233. In embodiments, the debug agent 230 may be a dedicated debugging tool, instead of a part of the normal functions for the computer device 200. The debug agent 230 may receive the error message transmitted by the device programmer 203 during the interaction 605, and determine to send a probe input signal to the device programmer 203, which further instructs the processor 201 to stop operations and perform debugging operations.

During an interaction 609, the device programmer may transmit a probe input signal to the processor to halt the execution of the program on the processor. For example, at the interaction 609, the device programmer 203 may transmit a probe input signal to the processor 201 to halt the execution of the program 215 on the processor 201. The probe input signal, e.g., a probe request (PREQ) signal, may be transmitted through the connection between the probe input signal port 242 and the probe input signal port 222.

During an interaction 611, the device programmer may receive a probe output signal from the processor to indicate that the execution of the program on the processor is halt. For example, at the interaction 611, the device programmer 203 may receive a probe output signal, e.g., a control ready (PRDY) signal, from the processor 201 to indicate that the execution of the program 215 on the processor 201 is halt. The probe output signal may be received through the connection between the probe output signal port 244 and the probe output signal port 224.

During an interaction 613, the device programmer may transmit the probe output signal to the debug agent. For example, at the interaction 613, the device programmer 203 may transmit the probe output signal, e.g., a control ready (PRDY) signal, to the debug agent 230. The probe output signal may be transmitted through a connection between the probe output signal port 255 and the probe output signal port 235.

During an interaction 615, the device programmer may block removal of power to the device programmer or the processor, and prevent the processor from being reset until a debug apparatus is attached to the processor. For example, at the interaction 615, the device programmer 203 may block removal of power to the device programmer 203 or the processor 201, and prevent the processor from being reset until a debug apparatus is attached to the processor 201. In embodiments, the device programmer 203 may block removal of power to the device programmer or the processor through controlling the power port 245 or the power port 225. The device programmer 203 may detect that a debug apparatus, e.g., a debug apparatus similar to the debug apparatus 350, is attached to the processor 201 through the debug data port 223.

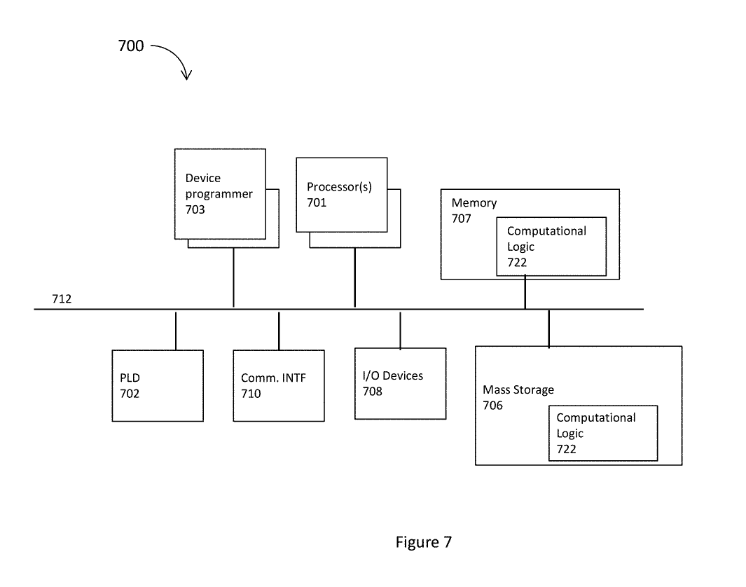

FIG. 7 illustrates an example communication device 700 that may be suitable as a device to practice selected aspects of the present disclosure. As shown, the device 700 may include one or more processors 701, each having one or more processor cores. The device 700 may be an example of the computer device 100 as shown in FIG. 1, the computer device 200 as shown in FIG. 2, or the computer device 300 as shown in FIG. 3, and the one or more processors 701 may be an example of the processor 101 as shown in FIG. 1, the processor 201 as shown in FIG. 2, or the processor 301 as shown in FIG. 3. In addition, the device 700 may include a device programmer 703, and a PLD 702, which may be an example of the device programmer 103, and the PLD 102 as shown in FIG. 1, an example of the device programmer 203, and the PLD 202 as shown in FIG. 2, or an example of the device programmer 303, and the PLD 302 as shown in FIG. 3. Furthermore, the device 700 may include a memory 707, which may be any one of a number of known persistent storage media; a mass storage 706, and one or more input/output devices 708. Furthermore, the device 700 may include a communication interface 710. The communication interface 710 may be any one of a number of known communication interfaces. The elements may be coupled to each other via system bus 712, which may represent one or more buses. In the case of multiple buses, they may be bridged by one or more bus bridges (not shown).

Each of these elements may perform its conventional functions known in the art. In particular, the system memory 707 may be employed to store a working copy and a permanent copy of the programming instructions implementing the operations associated with providing a secure back channel in wireless display systems, as described in connection with FIGS. 1-6, and/or other functions, collectively referred to as computational logic 722 that provides the capability of the embodiments described in the current disclosure. The various elements may be implemented by assembler instructions supported by processor(s) 701 or high-level languages, such as, for example, C, that can be compiled into such instructions.

The number, capability and/or capacity of these elements 701-722 may vary, depending on the number of other devices the device 700 is configured to support. Otherwise, the constitutions of elements 701-722 are known, and accordingly will not be further described.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module,” or “system.”

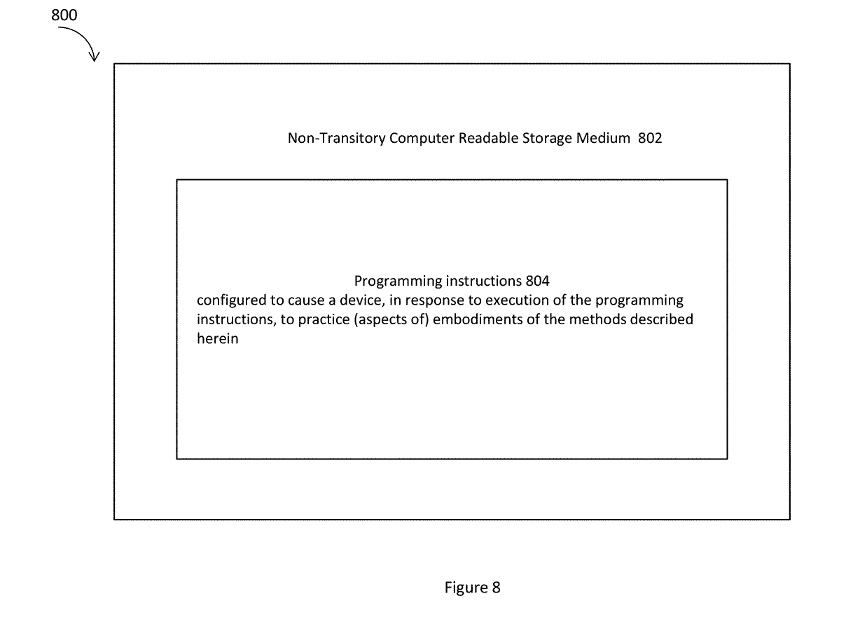

Furthermore, the present disclosure may take the form of a computer program product embodied in any tangible or non-transitory medium of expression having computer-usable program code embodied in the medium. FIG. 8 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 802 may include a number of programming instructions 804. Programming instructions 804 may be configured to enable a device, e.g., device 700, in response to execution of the programming instructions, to perform, e.g., various operations associated with the processor 101 as shown in FIG. 1, the processor 201 as shown in FIG. 2, or the processor 301 as shown in FIG. 3, or the device programmer 103 as shown in FIG. 1, the device programmer 203 as shown in FIG. 2, or the device programmer 303 as shown in FIG. 3.

In alternate embodiments, programming instructions 804 may be disposed on multiple computer-readable non-transitory storage media 802 instead. In alternate embodiments, programming instructions 804 may be disposed on computer-readable transitory storage media 802, such as, signals. Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Embodiments may be implemented as a computer process, a computing system or as an article of manufacture such as a computer program product of computer readable media. The computer program product may be a computer storage medium readable by a computer system and encoding computer program instructions for executing a computer process.

The corresponding structures, material, acts, and equivalents of all means or steps plus function elements in the claims below are intended to include any structure, material or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiments are chosen and described in order to best explain the principles of the disclosure and the practical application, and to enable others of ordinary skill in the art to understand the disclosure for embodiments with various modifications as are suited to the particular use contemplated.

Thus various example embodiments of the present disclosure have been described including, but are not limited to:

Example 1 may include a computer device, comprising: a processor; and a device programmer coupled to the processor to: receive an error message from the processor during an execution of a program on the processor; transmit a probe input signal to the processor to halt the execution of the program on the processor; and receive a probe output signal from the processor to indicate that the execution of the program on the processor is halt.

Example 2 may include the computer device of example 1, wherein the device programmer is to further: enable an option for the probe input signal before transmission of the probe input signal to the processor.

Example 3 may include the computer device of example 1, wherein the device programmer is to further: block removal of power to the device programmer or the processor; and prevent the processor from being reset until a debug apparatus is attached to the processor.

Example 4 may include the computer device of example 1, wherein the device programmer is to further: receive another probe input signal from a debug agent coupled to the device programmer; and transmit the probe output signal to the debug agent.

Example 5 may include the computer device of any one of examples 1-4, wherein the device programmer and the processor are on a same die or a same board.

Example 6 may include the computer device of any one of examples 1-4, wherein the device programmer is a gang programmer, a development programmer, a pocket programmer, or a specialized programmer.

Example 7 may include the computer device of any one of examples 1-4, wherein the probe input signal is a probe request (PREQ) signal, and the probe output signal is a control ready (PRDY) signal.

Example 8 may include the computer device of any one of examples 1-4, wherein the processor is a microcontroller, a 16-bit processor, a 32-bit processor, a 64-bit processor, single core processor, multi-core processor, a digital signal processor, or an embedded processor.

Example 9 may include the computer device of any one of examples 1-4, wherein the error message is an exception, an input/output error, a fatal error, or a recoverable error.

Example 10 may include a computer device, comprising: a register; and a processor coupled to the register to: detect an error during an execution of a program on the processor; transmit an error message to a device programmer coupled to the processor; receive a probe input signal from the device programmer to stop the execution of the program on the processor; and on stoppage, transmit a probe output signal to the device programmer to indicate that the execution of the program on the processor has stopped.

Example 11 may include the computer device of example 10, wherein the processor is to further: preserve an operational state of the program at a time of the error; and stop the execution of the program before transmission of the probe output signal to the device programmer.

Example 12 may include the computer device of example 11, wherein the processor is to further: transmit the preserved operational state to a debug agent or an external debug apparatus.

Example 13 may include the computer device of any one of examples 10-12, wherein the device programmer and the processor are on a same die or a same board.

Example 14 may include the computer device of any one of examples 10-12, wherein the device programmer is a gang programmer, a development programmer, a pocket programmer, or a specialized programmer.

Example 15 may include the computer device of any one of examples 10-12, wherein the probe input signal is a probe request (PREQ) signal, and the probe output signal is a control ready (PRDY) signal.

Example 16 may include the computer device of any one of examples 10-12, wherein the processor is a microcontroller, a 16-bit processor, a 32-bit processor, a 64-bit processor, single core processor, multi-core processor, a digital signal processor, or an embedded processor.

Example 17 may include the computer device of any one of examples 10-12, wherein the error message is an exception, an input/output error, a fatal error, or a recoverable error.

Example 18 may include a computer device, comprising: a processor to: detect an error during an execution of a program on the processor; transmit an error message to a device programmer coupled to the processor; receive a probe input signal from the device programmer to stop the execution of the program on the processor; and transmit a probe output signal to the device programmer to indicate that the execution of the program on the processor has stopped; and the device programmer coupled to the processor to: receive the error message from the processor; transmit the probe input signal to the processor to stop the execution of the program on the processor; and receive the probe output signal from the processor.

Example 19 may include the computer device of example 18, wherein the processor is to further: preserve an operational state of the program at a time of the error; and stop the execution of the program before transmission of the probe output signal to the device programmer.

Example 20 may include the computer device of example 19, wherein the processor is to: transmit the preserved operational state to a debug agent or an external debug apparatus.

Example 21 may include the computer device of any one of examples 18-20, wherein the device programmer and the processor are on a same die or a same board.

Example 22 may include the computer device of any one of examples 18-20, wherein the device programmer is a gang programmer, a development programmer, a pocket programmer, or a specialized programmer.

Example 23 may include the computer device of any one of examples 18-20, wherein the probe input signal is a probe request (PREQ) signal, and the probe output signal is a control ready (PRDY) signal.

Example 24 may include the computer device of any one of examples 18-20, wherein the processor is a microcontroller, a 16-bit processor, a 32-bit processor, a 64-bit processor, single core processor, multi-core processor, a digital signal processor, or an embedded processor.

Example 25 may include the computer device of any one of examples 18-20, wherein the error message is an exception, an input/output error, a fatal error, or a recoverable error.

Example 26 may include a method for a computer device to handle errors, comprising: receiving, by a device programmer, an error message from a processor coupled to the device programmer during an execution of a program on the processor; transmitting, by the device programmer, a probe input signal to the processor to halt the execution of the program on the processor; and receiving, by the device programmer, a probe output signal from the processor to indicate that the execution of the program on the processor is halt.

Example 27 may include the method of example 26, further comprising: enabling an option for the probe input signal before transmission of the probe input signal to the processor.

Example 28 may include the method of example 26, further comprising: blocking removal of power to the device programmer or the processor; and preventing the processor from being reset until a debug apparatus is attached to the processor.

Example 29 may include the method of example 26, further comprising: receiving another probe input signal from a debug agent coupled to the device programmer; and transmitting the probe output signal to the debug agent.

Example 30 may include the method of any one of examples 26-29, wherein the device programmer and the processor are on a same die or a same board.

Example 31 may include the method of any one of examples 26-29, wherein the device programmer is a gang programmer, a development programmer, a pocket programmer, or a specialized programmer.

Example 32 may include the method of any one of examples 26-29, wherein the probe input signal is a probe request (PREQ) signal, and the probe output signal is a control ready (PRDY) signal.

Example 33 may include the method of any one of examples 26-29, wherein the processor is a microcontroller, a 16-bit processor, a 32-bit processor, a 64-bit processor, single core processor, multi-core processor, a digital signal processor, or an embedded processor.

Example 34 may include the method of any one of examples 26-29, wherein the error message is an exception, an input/output error, a fatal error, or a recoverable error.

Example 35 may include a method for a computer device to handle errors, comprising: detecting, by a processor, an error during an execution of a program on the processor; transmitting, by the processor, an error message to a device programmer coupled to the processor; receiving, by the processor, a probe input signal from the device programmer to stop the execution of the program on the processor; and on stoppage, transmitting, by the processor, a probe output signal to the device programmer to indicate that the execution of the program on the processor has stopped.

Example 36 may include the method of example 35, further comprising: preserving an operational state of the program at a time of the error; and stopping the execution of the program before transmission of the probe output signal to the device programmer.

Example 37 may include the method of example 35, further comprising: transmitting the preserved operational state to a debug agent or an external debug apparatus.

Example 38 may include the method of any one of examples 35-37, wherein the device programmer and the processor are on a same die or a same board.

Example 39 may include the method of any one of examples 35-37, wherein the device programmer is a gang programmer, a development programmer, a pocket programmer, or a specialized programmer.

Example 40 may include the method of any one of examples 35-37, wherein the probe input signal is a probe request (PREQ) signal, and the probe output signal is a control ready (PRDY) signal.

Example 41 may include the method of any one of examples 35-37, wherein the processor is a microcontroller, a 16-bit processor, a 32-bit processor, a 64-bit processor, single core processor, multi-core processor, a digital signal processor, or an embedded processor.

Example 42 may include the method of any one of examples 35-37, wherein the error message is an exception, an input/output error, a fatal error, or a recoverable error.

Example 43 may include an apparatus for a computer device to handle errors, comprising: means for receiving an error message from a processor coupled to a device programmer during an execution of a program on the processor; means for transmitting a probe input signal to the processor to halt the execution of the program on the processor; and means for receiving a probe output signal from the processor to indicate that the execution of the program on the processor is halt.

Example 44 may include the apparatus of example 43, further comprising: means for enabling an option for the probe input signal before transmission of the probe input signal to the processor.

Example 45 may include the apparatus of example 43, further comprising: means for blocking removal of power to the device programmer or the processor; and means for preventing the processor from being reset until a debug apparatus is attached to the processor.

Example 46 may include the apparatus of example 43, further comprising: means for receiving another probe input signal from a debug agent coupled to the device programmer; and means for transmitting the probe output signal to the debug agent.

Example 47 may include the apparatus of any one of examples 43-46, wherein the device programmer and the processor are on a same die or a same board.

Example 48 may include the apparatus of any one of examples 43-46, wherein the device programmer is a gang programmer, a development programmer, a pocket programmer, or a specialized programmer.

Example 49 may include the apparatus of any one of examples 43-46, wherein the probe input signal is a probe request (PREQ) signal, and the probe output signal is a control ready (PRDY) signal.

Example 50 may include the apparatus of any one of examples 43-46, wherein the processor is a microcontroller, a 16-bit processor, a 32-bit processor, a 64-bit processor, single core processor, multi-core processor, a digital signal processor, or an embedded processor.

Example 51 may include the apparatus of any one of examples 43-46, wherein the error message is an exception, an input/output error, a fatal error, or a recoverable error.

Example 52 may include an apparatus for a computer device to handle errors, comprising: means for detecting an error during an execution of a program on a processor; means for transmitting an error message to a device programmer coupled to the processor; means for receiving a probe input signal from the device programmer to stop the execution of the program on the processor; and means for on stoppage, transmitting a probe output signal to the device programmer to indicate that the execution of the program on the processor has stopped.

Example 53 may include the apparatus of example 52, further comprising: means for preserving an operational state of the program at a time of the error; and means for stopping the execution of the program before transmission of the probe output signal to the device programmer.

Example 54 may include the apparatus of example 52, further comprising: means for transmitting the preserved operational state to a debug agent or an external debug apparatus.

Example 55 may include the apparatus of any one of examples 52-54, wherein the device programmer and the processor are on a same die or a same board.

Example 56 may include the apparatus of any one of examples 52-54, wherein the device programmer is a gang programmer, a development programmer, a pocket programmer, or a specialized programmer.

Example 57 may include the apparatus of any one of examples 52-54, wherein the probe input signal is a probe request (PREQ) signal, and the probe output signal is a control ready (PRDY) signal.

Example 58 may include the apparatus of any one of examples 52-54, wherein the processor is a microcontroller, a 16-bit processor, a 32-bit processor, a 64-bit processor, single core processor, multi-core processor, a digital signal processor, or an embedded processor.

Example 59 may include the apparatus of any one of examples 52-54, wherein the error message is an exception, an input/output error, a fatal error, or a recoverable error.

Example 60 may include one or more computer-readable media having instructions for a computer device to handle errors, upon execution of the instructions by one or more processors, to perform the method of any one of examples 26-42.

Although certain embodiments have been illustrated and described herein for purposes of description this application is intended to cover any adaptations or variations of the embodiments discussed herein. Therefore, it is manifestly intended that embodiments described herein be limited only by the claims.

What is claimed is:

1. A computer device, comprising:
a processor; and
a device programmer coupled to the processor to:
receive an error message from the processor during an execution of a program on the processor;
transmit a probe input signal to the processor to halt the execution of the program on the processor; and
receive a probe output signal from the processor to indicate that the execution of the program on the processor is halt.

2. The computer device of claim 1, wherein the device programmer is to further:
enable an option for the probe input signal before transmission of the probe input signal to the processor.

3. The computer device of claim 1, wherein the device programmer is to further:
block removal of power to the device programmer or the processor; and
prevent the processor from being reset until a debug apparatus is attached to the processor.

4. The computer device of claim 1, wherein the device programmer is to further:
receive another probe input signal from a debug agent coupled to the device programmer; and
transmit the probe output signal to the debug agent.

5. The computer device of claim 1, wherein the device programmer and the processor are on a same die or a same board.

6. The computer device of claim 1, wherein the device programmer is a gang programmer, a development programmer, a pocket programmer, or a specialized programmer.

7. The computer device of claim 1, wherein the probe input signal is a probe request (PREQ) signal, and the probe output signal is a control ready (PRDY) signal.

8. The computer device of claim 1, wherein the processor is a microcontroller, a 16-bit processor, a 32-bit processor, a 64-bit processor, single core processor, multi-core processor, a digital signal processor, or an embedded processor.

9. The computer device of claim 1, wherein the error message is an exception, an input/output error, a fatal error, or a recoverable error.

10. A computer device, comprising:
a register; and
a processor coupled to the register to:
detect an error during an execution of a program on the processor;
transmit an error message to a device programmer coupled to the processor;
receive a probe input signal from the device programmer to stop the execution of the program on the processor; and
on stoppage, transmit a probe output signal to the device programmer to indicate that the execution of the program on the processor has stopped.

11. The computer device of claim 10, wherein the processor is to further:
preserve an operational state of the program at a time of the error; and
stop the execution of the program before transmission of the probe output signal to the device programmer.

12. The computer device of claim 11, wherein the processor is to further:
transmit the preserved operational state to a debug agent or an external debug apparatus.

13. The computer device of claim 10, wherein the device programmer and the processor are on a same die or a same board.

14. The computer device of claim 10, wherein the device programmer is a gang programmer, a development programmer, a pocket programmer, or a specialized programmer.

15. The computer device of claim 10, wherein the probe input signal is a probe request (PREQ) signal, and the probe output signal is a control ready (PRDY) signal.

16. The computer device of claim 10, wherein the processor is a microcontroller, a 16-bit processor, a 32-bit processor, a 64-bit processor, single core processor, multi-core processor, a digital signal processor, or an embedded processor.

17. The computer device of claim 10, wherein the error message is an exception, an input/output error, a fatal error, or a recoverable error.

18. A computer device, comprising:
a processor to:
detect an error during an execution of a program on the processor;
transmit an error message to a device programmer coupled to the processor;
receive a probe input signal from the device programmer to stop the execution of the program on the processor; and
transmit a probe output signal to the device programmer to indicate that the execution of the program on the processor has stopped; and
the device programmer coupled to the processor to:
receive the error message from the processor;
transmit the probe input signal to the processor to stop the execution of the program on the processor; and
receive the probe output signal from the processor.

19. The computer device of claim 18, wherein the processor is to further:
preserve an operational state of the program at a time of the error; and
stop the execution of the program before transmission of the probe output signal to the device programmer.

20. The computer device of claim 19, wherein the processor is to:
transmit the preserved operational state to a debug agent or an external debug apparatus.

21. The computer device of claim 18, wherein the device programmer and the processor are on a same die or a same board.

22. The computer device of claim 18, wherein the device programmer is a gang programmer, a development programmer, a pocket programmer, or a specialized programmer.

23. The computer device of claim 18, wherein the probe input signal is a probe request (PREQ) signal, and the probe output signal is a control ready (PRDY) signal.

24. The computer device of claim 18, wherein the processor is a microcontroller, a 16-bit processor, a 32-bit processor, a 64-bit processor, single core processor, multi-core processor, a digital signal processor, or an embedded processor.

25. The computer device of claim 18, wherein the error message is an exception, an input/output error, a fatal error, or a recoverable error.
